(19) United States
(12) Patent Application Publication
(10) Pub. No.: US 2026/0361828 A1
(43) Pub. Date: Nov. 12, 2026

(54) IMAGE FORMING APPARATUS

(71) Applicant: CANON KABUSHIKI KAISHA, Tokyo (JP)

(72) Inventor: TOSHIMITSU NAKANO, Kanagawa (JP)

(21) Appl. No.: 19/664,583

(22) Filed: Apr. 30, 2026

(30) Foreign Application Priority Data
May 9, 2025 (JP) 2025-078623

(51) Int. Cl. H04N 1/32; H04N 1/00; G03G 15/00

(52) U.S. Cl. CPC H04N 1/3263; H04N 1/00602; H04N 1/00612; H04N 1/00615; G03G 15/70

(57) ABSTRACT

An image forming apparatus includes an image forming unit, a first discharge unit, a first conveyance path, a reversing conveyance path branched at a first branch portion, a duplex conveyance path merged with the first conveyance path at a merging portion, a second conveyance path branched from the first conveyance path at a second branch portion disposed on a downstream side of the merging portion, a jam detection unit configured to detect a jam of the sheet, a conveyance unit, and a control unit, wherein, in a case where a jam occurring between the image forming unit and the first branch portion is detected, the control unit controls the conveyance unit to convey a first sheet positioned at the second branch portion to a downstream of the second branch portion, and then to convey a second sheet positioned on an upstream side of the second branch portion.

### BACKGROUND

### Field of the Technology

The present disclosure relates to an image forming apparatus forming an image on a sheet.

### Description of the Related Art

In an image forming apparatus described in Japanese Patent No. 4909206, a sheet on which an image has been formed is discharged to a discharge unit. The image forming apparatus includes a branch conveyance path that is branched at a branch portion from a conveyance path through which the sheet passes in a case where the image is formed. The sheet having passed through the branch conveyance path is discharged to an escape tray. In a case where a sheet jam occurring in the image forming apparatus is detected, a sheet that cannot be conveyed to a discharge unit set as a discharge destination is discharged to the escape tray through the branch conveyance path.

To recover the image forming apparatus from the jam state, it is necessary for the user using the image forming apparatus to remove all sheets remaining inside the image forming apparatus. By discharging the sheets to the escape tray, it is possible to reduce the number of sheets to be removed for recovery.

When a jam occurs, in a case where the sheet is stopped while straddling the branch portion, the other sheets cannot be conveyed to the escape tray due to the stopped sheet. In this case, the number of sheets remaining inside the apparatus is increased. Thus, usability during jam recovery is insufficient.

### SUMMARY

According to an aspect of the present disclosure, an image forming apparatus includes an image forming unit configured to form an image on a sheet, a first discharge unit to which the sheet on which image formation is normally completed is discharged, a first conveyance path provided from a feeding unit configured to feed the sheet up to the first discharge unit through the image forming unit, and through which the sheet passes, a reversing conveyance path branched from the first conveyance path at a first branch portion, and configured to reverse a sheet conveyance direction of the sheet on which the image is formed on a first surface of the sheet, a duplex conveyance path disposed on a downstream side of the reversing conveyance path in the sheet conveyance direction, and merged with the first conveyance path at a merging portion, a second conveyance path branched from the first conveyance path at a second branch portion disposed on a downstream side of the merging portion and on an upstream side of the image forming unit, and through which the sheet passes toward a second discharge unit to which an abnormal sheet is discharged, a jam detection unit configured to detect jam of the sheet, a conveyance unit configured to convey the sheet, and a control unit configured to control the conveyance unit, wherein, in a case where a jam occurring between the image forming unit and the first branch portion in the sheet conveyance direction is detected by the jam detection unit, the control unit controls the conveyance unit to convey a first sheet positioned at the second branch portion to a downstream of the second branch portion in the sheet conveyance direction, and then to convey a second sheet positioned on an upstream side of the second branch portion in the sheet conveyance direction to the second discharge unit.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware block diagram of an image forming apparatus according to a present embodiment.

FIG. 2 is a cross-sectional view of the image forming apparatus.

FIG. 3 is a diagram illustrating a state of a sheet inside the apparatus when a jam is detected.

FIG. 4 is a diagram illustrating a sheet conveyance state during execution of print processing.

FIG. 5 is a diagram illustrating sheet information before a jam is detected.

FIG. 6 is a diagram illustrating sheet information in rerouting after a jam is detected.

FIG. 7 is a diagram illustrating a state where sheet processing ends when a jam occurs.

FIG. 8 is a diagram illustrating a state where a sheet is present at a branch point.

FIG. 9 is a flowchart of the sheet processing when a jam occurs.

FIG. 10 is a diagram illustrating a state after the sheet processing when a jam is detected.

FIG. 11 is a diagram illustrating a state of a conveyance pinch roller.

FIG. 12 is a diagram illustrating a state of the conveyance pinch roller when a jam occurs.

FIGS. 13A-13C are diagrams illustrating a switching flapper.

FIGS. 14A and 14B are diagrams illustrating a configuration of the conveyance pinch roller.

### DESCRIPTION OF THE EMBODIMENTS

An embodiment of the present disclosure is described below with reference to drawings.

### Hardware Configuration of Image Forming Apparatus

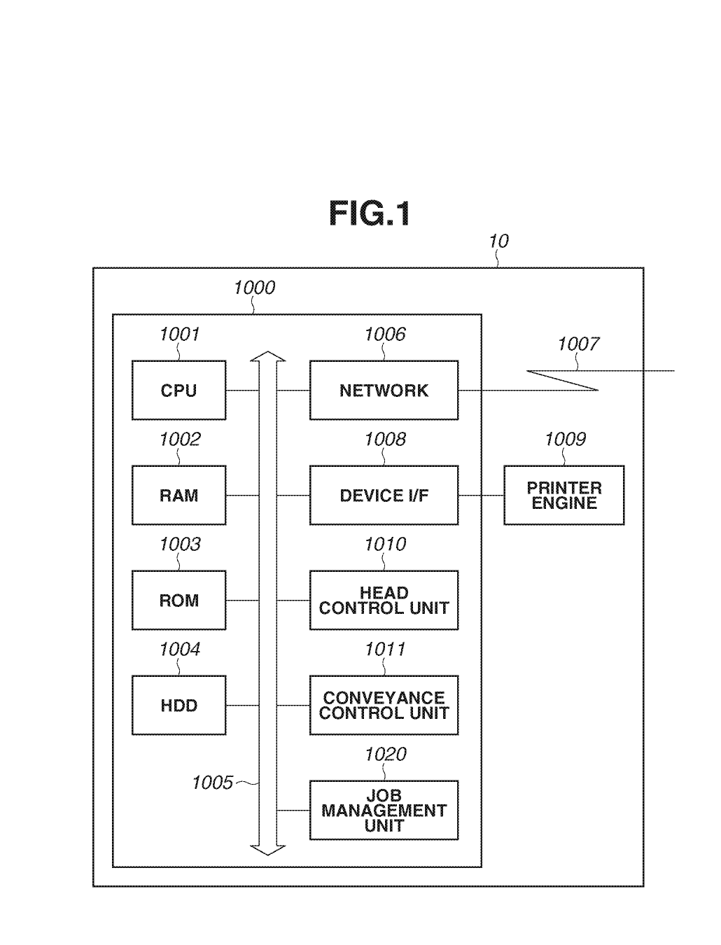

FIG. 1 is a hardware block diagram of an image forming apparatus 10 according to the present embodiment. A controller unit 1000 controls input/output of sensor signals and device information. A program in which processing contents are written is stored in a read only memory (ROM) 1003 or a hard disk drive (HDD) 1004, and is installed in the image forming apparatus 10. A central processing unit (CPU) 1001 reads out the program stored in the ROM 1003 or the HDD 1004 into a random access memory (RAM) 1002, and executes the program. Further, the CPU 1001 totally controls devices connected to a system bus 1005. The RAM 1002 functions as a main memory and a work memory for the CPU 1001. The ROM 1003 stores a boot program to be executed when power is turned on, and the HDD 1004 stores an operating system and a control program body of the apparatus. The HDD 1004 is also used for holding large-capacity data temporarily or for a long time. A network 1006 is connected to a local area network 1007, and performs input/output of data and device information with an outside. Alternatively, a program can be installed in the ROM 1003 or the HDD 1004 through the network 1006. A device interface (I/F) 1008 is an interface unit for a printer engine 1009, and performs input/output of signals for operating and referring to various kinds of motors, sensors, an inkjet head, and the like connected to the printer engine 1009. The printer engine 1009 is an inkjet output apparatus that conveys a print sheet in response to load control from the controller unit 1000, and controls the inkjet head to output an image onto the print sheet.

A job management unit 1020 receives a print job input through the network 1006, and performs management of conveyance timing of each sheet, allocation of a print image to each sheet, and setting of a discharge tray described below.

The conveyance control unit 1011 controls conveyance motors and sensors to perform feeding of each print sheet and discharge of each print sheet to the outside.

A head control unit 1010 controls the inkjet head provided in the printer engine 1009 through the device I/F 1008, and performs ink discharge control for image formation in synchronization with timing when the sheet reaches an ejection position of the ink head.

### Cross-Section of Image Forming Apparatus

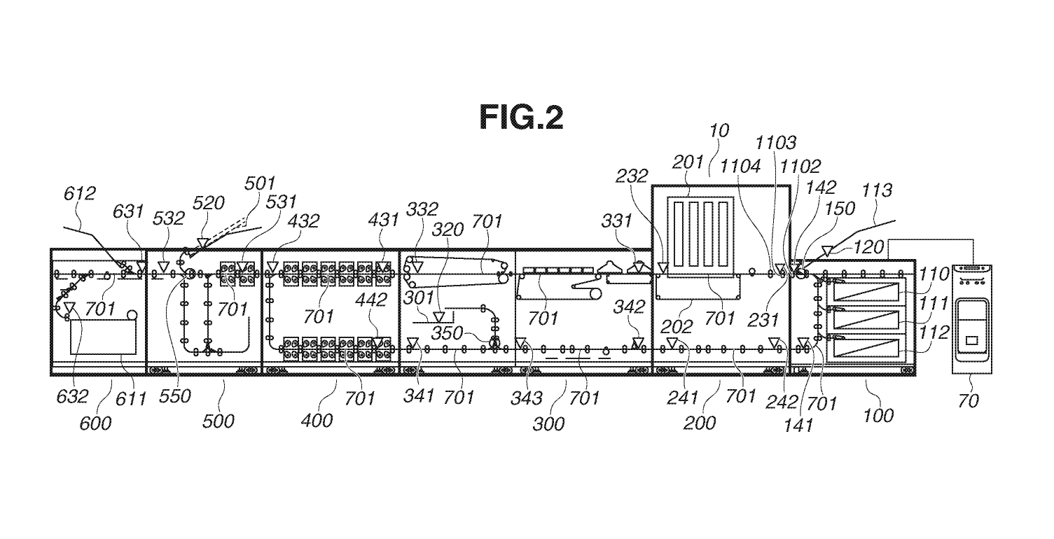

FIG. 2 is a cross-sectional view of the image forming apparatus 10 according to the present embodiment. The image forming apparatus 10 includes six units, namely, a feeding unit 100, a print unit 200, a fixing unit 300, a cooling unit 400, a reversing unit 500, and a stacker unit 600.

The print unit 200 is a unit printing a print image on a sheet. The print unit 200 includes an inkjet head 201 serving as an image forming unit, and a print belt 202 conveying the sheet to the inkjet head 201.

The fixing unit 300 is a unit performing fixing control for fixing the image formed on the sheet by the print unit 200, to the sheet, and fixes the print image by using a plurality of heater units (not illustrated). The fixing unit 300 includes a duplex-reversing escape tray 301 as an escape discharge tray. To switch a conveyance destination of the sheet to the duplex-reversing escape tray 301, the fixing unit 300 operates a flapper at a branch point 350.

The cooling unit 400 is a unit cooling the print sheet warmed by the fixing unit 300, and cools the print sheet by using a plurality of fan units (not illustrated).

The reversing unit 500 is a unit that performs sheet reversing control by switching back the conveyed sheet in order to direct a printed surface upward or downward when the print sheet is stacked on the subsequent stacker unit 600. The reversing unit 500 includes a reversing-unit escape tray 501 as an escape discharge tray. To switch a conveyance destination of the sheet to the reversing-unit escape tray 501, the reversing unit 500 operates a flapper at a branch point 550.

The stacker unit 600 is a unit that discharges and stacks the printed print sheet, and includes a discharge stacker tray 611 and an upper discharge tray 612 as examples of a first discharge unit. The stacker unit 600 includes a roller pair that discharges the sheet on which the image has been formed by the inkjet head 201, to the discharge stacker tray 611 or the upper discharge tray 612. The discharged sheet is stacked on the discharge stacker tray 611 or the upper discharge tray 612.

In a case where an image is formed on one surface of a sheet, the sheet on which the image has been formed on the one surface is conveyed from the cooling unit 400 to the reversing unit 500. Thereafter, the sheet is conveyed from the reversing unit 500 to the stacker unit 600.

In a case where images are formed on both surfaces of a sheet, the sheet on which the image has been formed on one surface is U-turned by the cooling unit 400, and is conveyed to the fixing unit 300 through a conveyance path disposed on a lower part of the cooling unit 400. The sheet having been conveyed to the fixing unit 300 is switched back and conveyed by the fixing unit 300. The sheet having been switched back and conveyed by the fixing unit 300 is conveyed to the print unit 200. Thereafter, the sheet is conveyed to the feeding unit 100 through a conveyance path disposed on a lower part of the print unit 200. The sheet sent to the feeding unit 100 is conveyed to the print unit 200 again, and an image is formed on a rear surface of the sheet by the inkjet head 201. The sheet on which the image has been formed on the rear surface is conveyed from the cooling unit 400 to the reversing unit 500. Thereafter, the sheet is conveyed from the reversing unit 500 to the stacker unit 600.

Each of the feeding unit 100, the print unit 200, the fixing unit 300, the cooling unit 400, the reversing unit 500, and the stacker unit 600 includes conveyance rollers serving as a conveyance unit conveying the sheet along a conveyance path 701.

Each of the units includes conveyance path sensors configuring a jam detection unit, and can determine whether a sheet under conveyance is jammed. For example, conveyance path sensors 331, 332, 341, 342, and 343 are disposed in the fixing unit 300. Other conveyance path sensors 141, 142, 231, 232, 241, 242, 431, 432, 442, 531, 532, 631, and 632 are also used for determination of a sheet jam in a similar manner. The CPU 1001 detects a timing when a leading end and a trailing end of each sheet pass through each of the conveyance path sensors, by a signal from each of the conveyance path sensors. Jam detection is described below. A sensor 120 detects a sheet on a feeding-unit escape tray 113. A sensor 320 detects a sheet on the duplex-reversing escape tray 301. A sensor 520 detects a sheet on the reversing-unit escape tray 501.

A print server 70 is connected to the image forming apparatus 10, and a print job is transmitted from the print server 70. The print server 70 can check a state of the image forming apparatus 10, monitor a print job, and perform maintenance control, and can totally operate various kinds of functions held by the image forming apparatus 10.

### Sheet Processing When Jam Occurs

Next, sheet processing when a jam occurs is described.

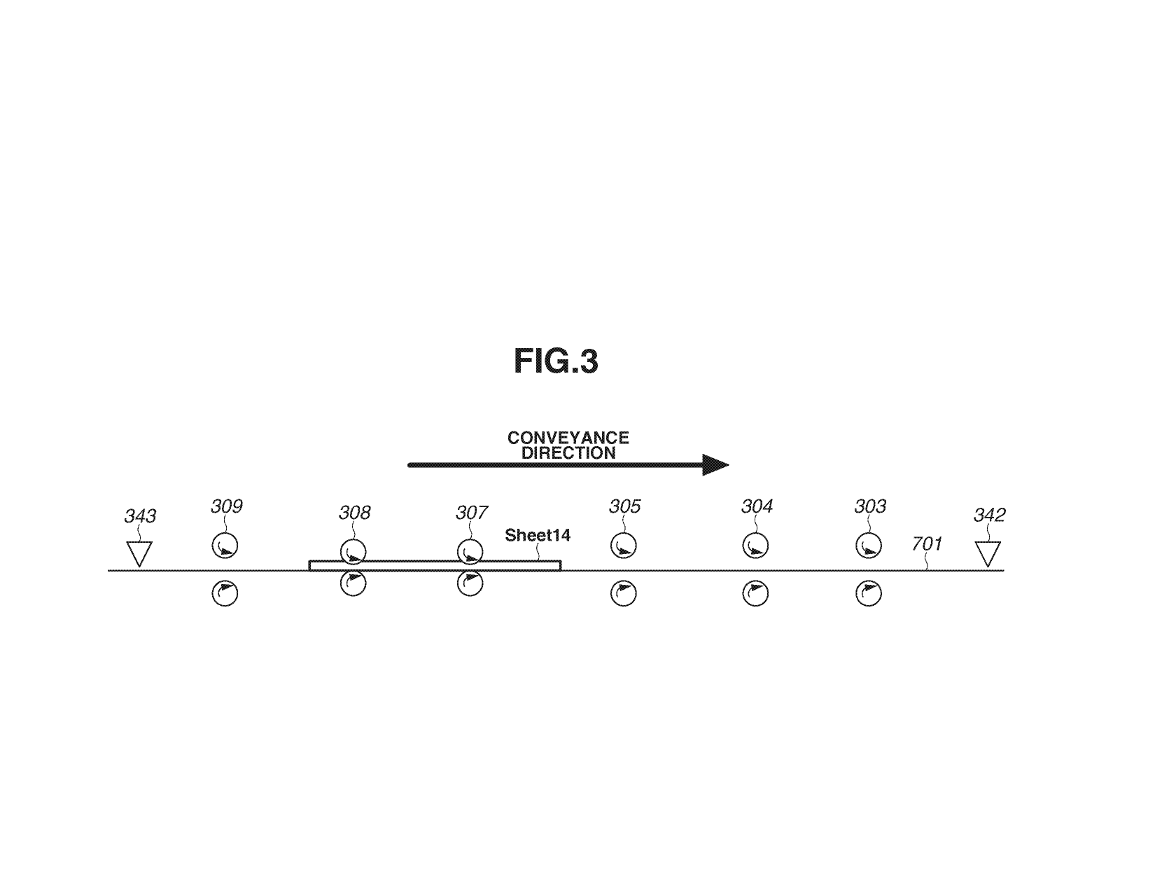

A sequence of the sheet processing in a case where a jam is detected in a duplex print job is described on cross-sectional views of the image forming apparatus with reference to FIGS. 3-6.

### Detection of Jam

A jam detection method using the conveyance path sensor 343 provided on an upstream in a conveyance direction and the conveyance path sensor 342 provided on a downstream side is described with reference to FIG. 3. FIG. 3 is an enlarged view of a portion A illustrated in FIG. 2. In FIG. 3, Sheet 14 (sheet) is conveyed on the conveyance path 701 in the conveyance direction by pinch roller pairs 303 to 309 included in the conveyance unit conveying the sheet.

In a case where the conveyance path sensor 342 does not detect Sheet 14 even when a predetermined time elapses after a leading end of Sheet 14 is detected by the conveyance path sensor 343, the CPU 1001 determines that Sheet 14 is not normally conveyed. In other words, in this case, the CPU 1001 configuring the jam detection unit together with the conveyance path sensors determines that Sheet 14 is jammed between the conveyance path sensor 343 and the conveyance path sensor 342. In a case where a trailing end of Sheet 14 is not detected even when a predetermined time based on a length of Sheet 14 elapses after the conveyance path sensor 343 detects the leading end of Sheet 14, the CPU 1001 determines that Sheet 14 is not normally conveyed. In other words, in this case, the CPU 1001 determines that Sheet 14 is jammed at a position of the conveyance path sensor 343. Here, jam determination using the conveyance path sensor 343 provided on the upstream in the conveyance direction and the conveyance path sensor 342 provided on the downstream side is exemplified. The CPU 1001 determines a sheet jam in a similar manner based on the other conveyance path sensors 141, 142, 231, 232, 241, 242, 431, 432, 442, 531, 532, 631, and 632.

### Rerouting When Jam is Detected

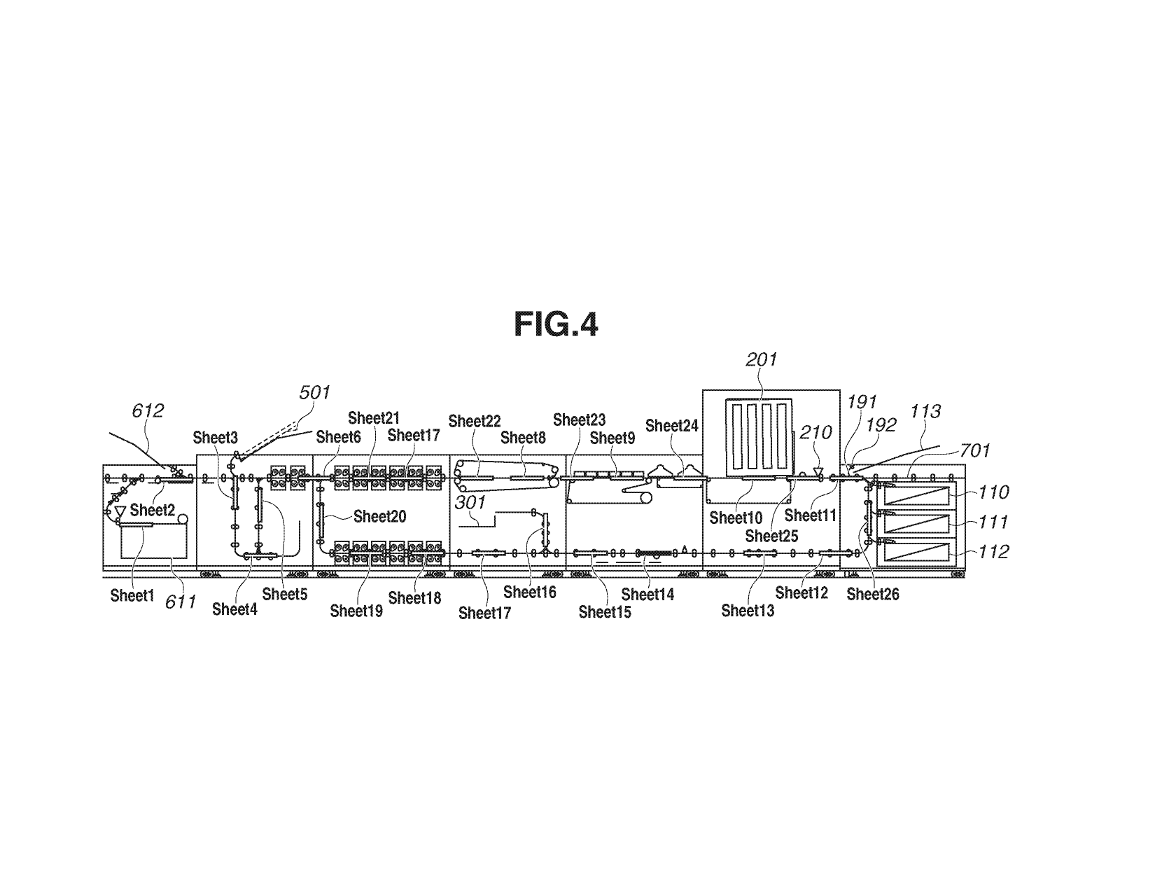

Reroute processing when a jam is detected is described with reference to FIGS. 4-7.

FIG. 4 illustrates a sheet conveyance state when print processing of a duplex 26-sheet job is performed, and 26 sheets from Sheet 1 to Sheet 26 are conveyed inside the image forming apparatus.

An example in which, at a timing when the sheets are present at respective positions illustrated in FIG. 4, Sheet 14 in a single-surface printed state illustrated in FIG. 3 is jammed just before the conveyance path sensor 342 is described.

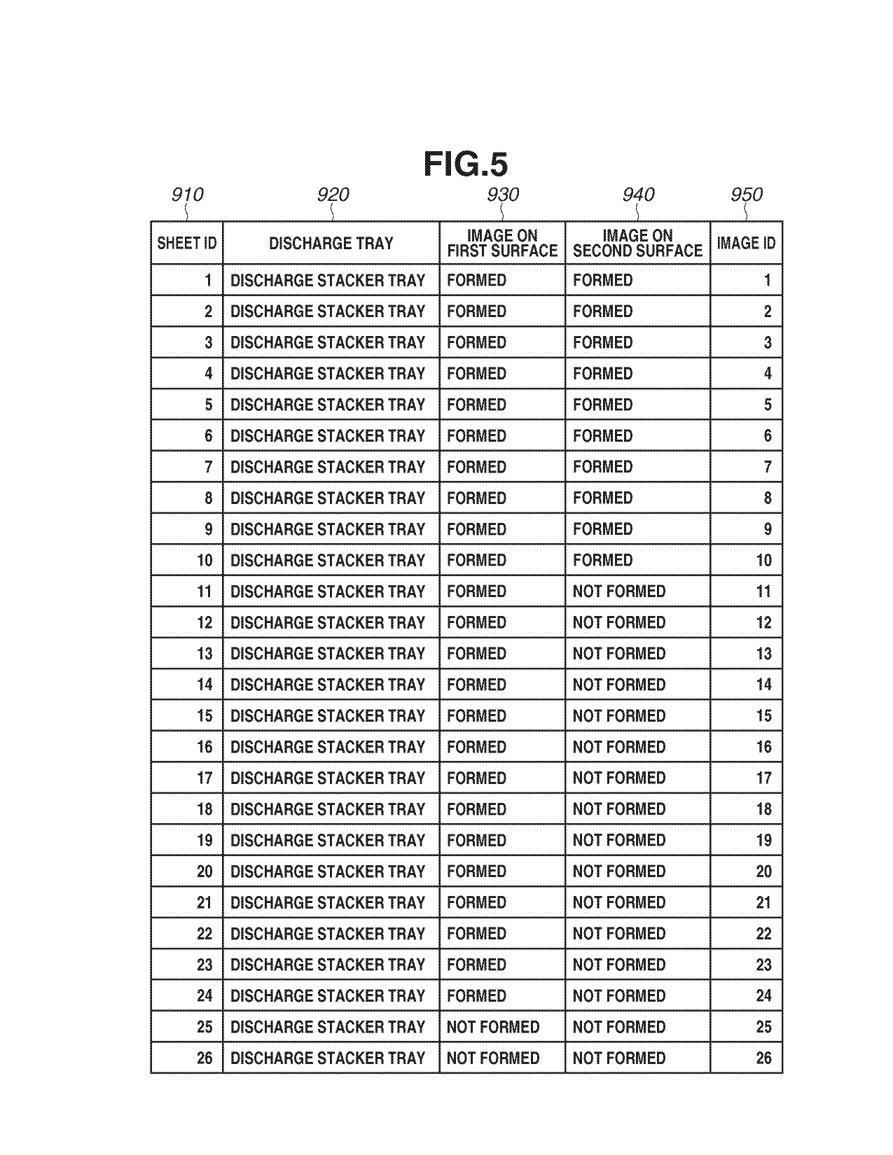

FIG. 5 illustrates sheet information managed by the job management unit 1020 in the sheet conveyance state illustrated in FIG. 4 before a jam is detected.

A Sheet-id column 910 indicates the sheets from Sheet 1 to Sheet 26. A discharge-tray column 920 indicates setting of a discharge tray to which each sheet is to be discharged.

As the discharge tray, the discharge stacker tray 611, the upper discharge tray 612, the duplex-reversing escape tray 301, the feeding-unit escape tray 113, or the reversing-unit escape tray 501 is set. An image-on-first-surface column 930 indicates whether an image has been formed on a first surface of each sheet, and an image-on-second-surface column 940 indicates whether an image has been formed on a second surface of each sheet. When image formation is started, information indicating formed is stored, whereas when image formation is not yet started, information indicating not-formed is stored. In a case of a single-sided job in which an image is formed only on one surface of a sheet, image formation is not performed on a second surface (rear surface) of the sheet, and accordingly, information indicating none is stored. An Image-id column 950 indicates an image identification (ID) of an image to be formed on each sheet. In the example illustrated in FIG. 5, as a parameter in the discharge-tray column 920, the discharge stacker tray 611 is set to all the sheets from Sheet 1 to Sheet 26.

When a jam caused by Sheet 14 occurs in the sheet conveyance state illustrated in FIG. 4, conveyance of Sheet 14 that is a jam-causing sheet (hereinafter, referred to as jam sheet) is stopped. An escape conveyance path extending toward the duplex-reversing escape tray 301 is provided on an upstream side of a jam occurrence position in the conveyance direction. Even when conveyance of Sheet 14 is stopped, Sheet 16 to Sheet 20 can be discharged to the duplex-reversing escape tray 301 through the escape conveyance path. Therefore, escape discharge processing for the sheets is performed. On the other hand, an escape tray is not disposed between a position of Sheet 15 and the jam occurrence position. In other words, a branch point branched to the escape conveyance path for sending a sheet to an escape tray is not present between the position of Sheet 15 and the jam occurrence position. Therefore, escape discharge processing for Sheet 15 is not performed, and conveyance of Sheet 15 is stopped. Conveyance of the sheets each having Sheet ID after Sheet 14 as the jam sheet is stopped, or the sheets are discharged to the escape tray.

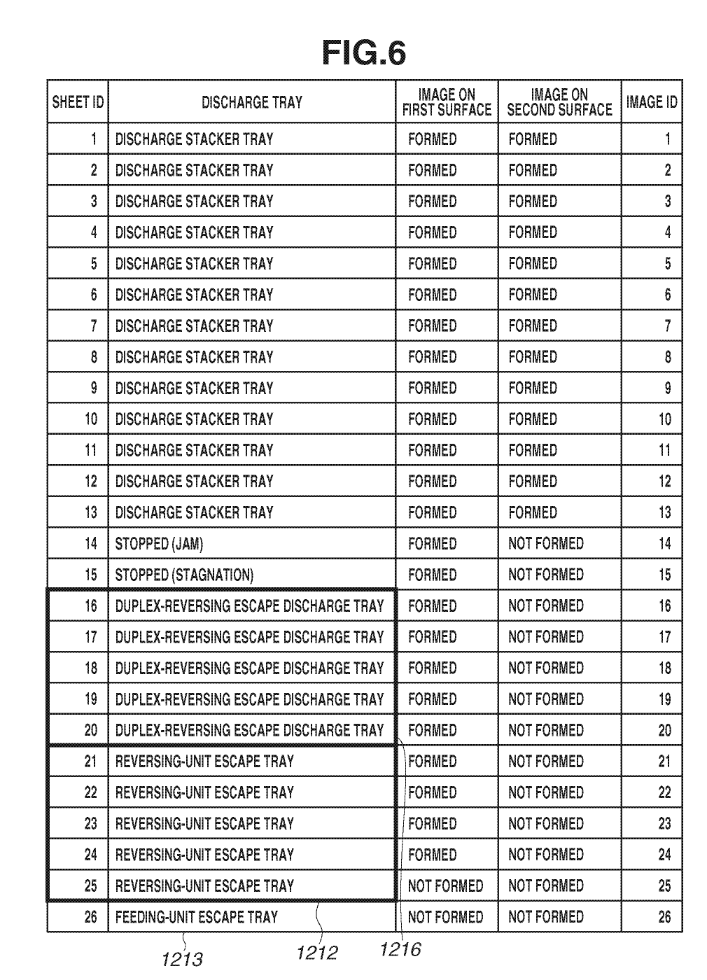

FIG. 6 illustrates sheet information managed by the job management unit 1020 in rerouting when a jam occurs. When a jam of Sheet 14 is detected, the CPU 1001 serving as the control unit handles Sheet 15 and following sheets as abnormal sheets, and the parameters of the abnormal sheets in the discharge-tray column 920 are changed to predetermined escape trays. Conveyance of Sheet 15 is stopped as described above. Therefore, the discharge tray parameters of Sheet 16 to Sheet 20 are each changed to the duplex-reversing escape tray (1216). Likewise, the discharge tray parameters of Sheet 21 to Sheet 25 are each changed to the reversing-unit escape tray 501 (1212). The discharge tray parameter of Sheet 26 is changed to the feeding-unit escape tray 113 as an example of a second discharge unit (1213). The escape tray to be selected as the discharge tray parameter depends on a position of each sheet in the conveyance path 701.

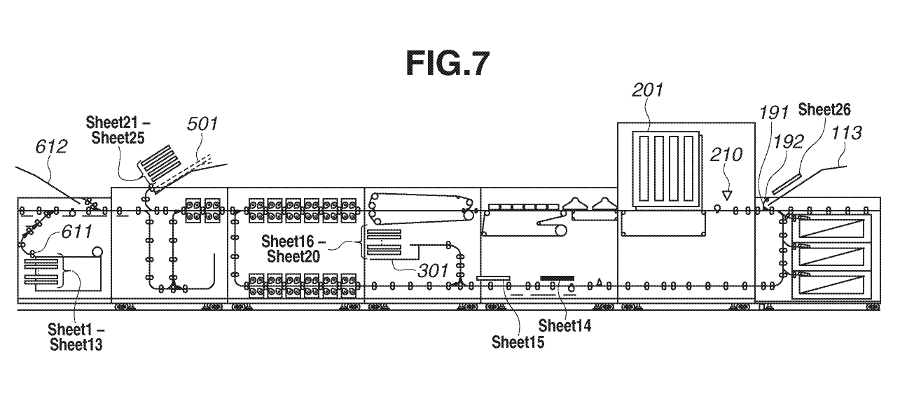

FIG. 7 illustrates a state where the sheet conveyance processing after a jam occurs ends. Sheet 14 as the jam sheet and Sheet 15 remain inside the apparatus. Sheet 16 to Sheet 20 are discharged to the duplex-reversing escape tray 301. Sheet 21 to Sheet 25 are discharged to the reversing-unit escape tray 501. Sheet 26 is discharged to the feeding-unit escape tray 113. The other sheets are all discharged to the discharge stacker tray 611 that is a normal discharge destination. In this state, the processing ends.

When removal of the sheets remaining inside the image forming apparatus and the sheets on the duplex-reversing escape tray 301 is detected by all the conveyance path sensors and the sensor 320, the error is cleared, and the print job is resumed.

### Sheet Processing When Jam Occurs

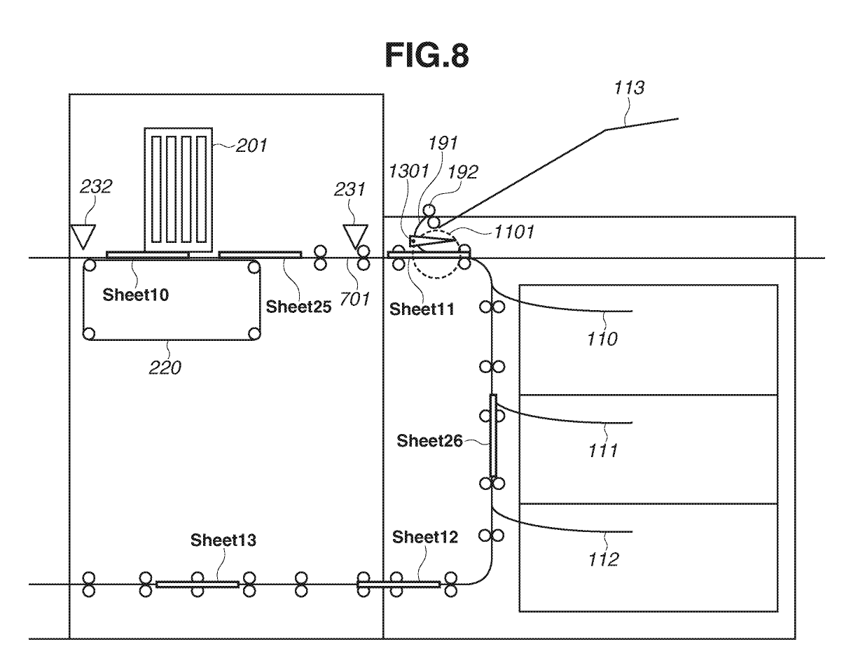

Next, sheet processing when a jam occurs is described with reference to FIGS. 8, 9, 10, and 13A-13C.

In the present embodiment, in a case where a sheet determined to be stopped is present at the branch point to the escape tray when a jam occurs, the sheet is moved to a position not blocking the conveyance path for conveying the sheet to the escape tray, and is then stopped. The branch point is described below.

Switching from a normal conveyance path through which the sheet passes in print processing to the escape path extending toward the escape tray is performed by a switching flapper serving as a guiding unit guiding the sheet.

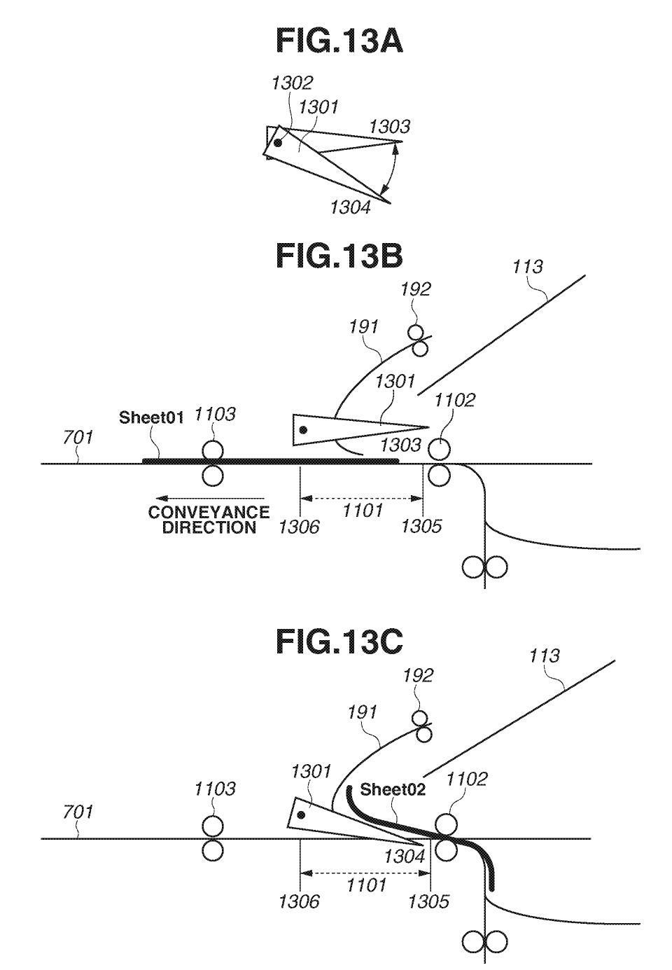

FIGS. 13A-13C are diagrams illustrating a switching flapper 1301 that switches the sheet conveyance destination to an escape conveyance path 191 guiding the sheet to the feeding-unit escape tray 113.

FIG. 13A illustrates a configuration of the switching flapper 1301.

The switching flapper 1301 is rotated around a shaft 1302 by a motor (not illustrated), operation of which is controlled by the CPU 1001. A position of the switching flapper 1301 can be switched to a first position 1303 and a second position 1304.

FIG. 13B is a diagram illustrating a state of the switching flapper 1301 in a normal state, namely, when printing of the sheet is performed.

During execution of the normal print processing, the switching flapper 1301 maintains the first position 1303, and the sheet passes through a lower surface of the switching flapper 1301, and is conveyed through the normal conveyance path 701 (first conveyance path). The conveyance path 701 is a conveyance path through which the sheet passes when image forming processing is performed on the sheet.

FIG. 13C is a diagram illustrating a state of the switching flapper 1301 in a case where the sheet is conveyed to the feeding-unit escape tray 113. In a case where the sheet is guided to the feeding-unit escape tray 113, the switching flapper 1301 is at the second position 1304. In other words, the switching flapper 1301 at the second position 1304 guides the sheet to the escape conveyance path 191 through which the sheet heading the feeding-unit escape tray 113 passes. The sheet having passed through the escape conveyance path 191 serving as a second conveyance path is discharged to the feeding-unit escape tray 113 by a discharge roller pair 192. The escape conveyance path 191 directing the sheet to the feeding-unit escape tray 113 is branched from the normal conveyance path 701 at a branch portion that is a position of a tip of the switching flapper 1301. In other words, to discharge a defective sheet on which image formation is incomplete when a jam occurs, to the feeding-unit escape tray 113, the CPU 1001 controls the motor to switch the position of the switching flapper 1301 to the second position 1304. Therefore, Sheet02 passes through an upper surface of the switching flapper 1301, and is conveyed to the escape conveyance path 191 toward the feeding-unit escape tray 113.

At the tip of the switching flapper 1301 at the second position 1304, the escape conveyance path 191 extending toward the feeding-unit escape tray 113 is branched from the normal conveyance path 701 illustrated in FIGS. 13B and 13C. A region from the tip of the switching flapper 1301 at the second position 1304 to a position 1305 of the shaft of the switching flapper 1301 is set as a branch point 1101. In the present embodiment, in a state where even a part of the sheet from the leading end to the trailing end is present in (straddles) the region of the branch point 1101, the sheet becomes an obstacle, and the position of the switching flapper 1301 cannot be switched. Therefore, to switch the position of the switching flapper, it is necessary that the sheet does not straddle the region of the branch point.

The unit including the escape tray includes the switching flapper and the branch point. For example, the fixing unit 300 includes a switching flapper and the branch point 350 for the duplex-reversing escape tray 301, and the reversing unit 500 includes a switching flapper and the branch point 550 for the reversing-unit escape tray 501. In the present embodiment, the conveyance path is switched using the switching flapper; however, the conveyance path may be switched using other well-known methods.

FIG. 8 is a diagram illustrating a state where Sheet 11 is present at the branch point 1101 to the escape conveyance path 191.

An example in which Sheet 10 is jammed just before the conveyance path sensor 232 is described. In a case where the conveyance path sensor 232 does not detect a sheet even when a predetermined time elapses after a leading end of Sheet 10 is detected by the conveyance path sensor 231, the CPU 1001 determines that Sheet 10 is not normally conveyed. In other words, the CPU 1001 determines that Sheet 10 is jammed between the conveyance path sensor 231 and the conveyance path sensor 232.

In FIG. 8, in a case where Sheet 10 is jammed between the conveyance path sensor 231 and the conveyance path sensor 232, a branch point at which an escape conveyance path extending toward an escape tray is branched is absent between a position of each of Sheet 25 and Sheet 11 and the jam occurrence position. Therefore, sheet conveyance is stopped without performing escape discharge processing for Sheet 10, Sheet 25, and Sheet 11. In the present embodiment, the escape tray at this time is any of the feeding-unit escape tray 113, the duplex-reversing escape tray 301, and the reversing-unit escape tray 501. The escape conveyance path extending toward the escape tray at this time is a conveyance path that is branched from the conveyance path 701 and directs the sheet to any of the feeding-unit escape tray 113, the duplex-reversing escape tray 301, and the reversing-unit escape tray 501.

At this time, Sheet 11 is at a position straddling the branch point 1101 (indicated by dashed line) to the feeding-unit escape tray 113 illustrated in FIGS. 13B and 13C. If Sheet 11 is stopped, the position of the flapper 1301 cannot be switched due to Sheet 11, and the escape conveyance path 191 extending toward the feeding-unit escape tray 113 is blocked. When the escape conveyance path 191 extending toward the feeding-unit escape tray 113 is blocked, Sheet 26, Sheet 12, and Sheet 13 positioned on the upstream side of Sheet 11 cannot be discharged to the feeding-unit escape tray 113, and remain inside the apparatus.

Therefore, in the present embodiment, sheet stop processing for causing the sheet not to block the escape conveyance path 191 extending toward the feeding-unit escape tray 113 is performed. More specifically, Sheet 11 at the position straddling the branch point is moved to a position not inhibiting conveyance of the other sheets to the escape conveyance path 191, to secure the escape conveyance path 191. This makes it possible to discharge the sheets positioned on the upstream side of Sheet 11 in the sheet conveyance direction, to the feeding-unit escape tray 113 through the escape conveyance path 191.

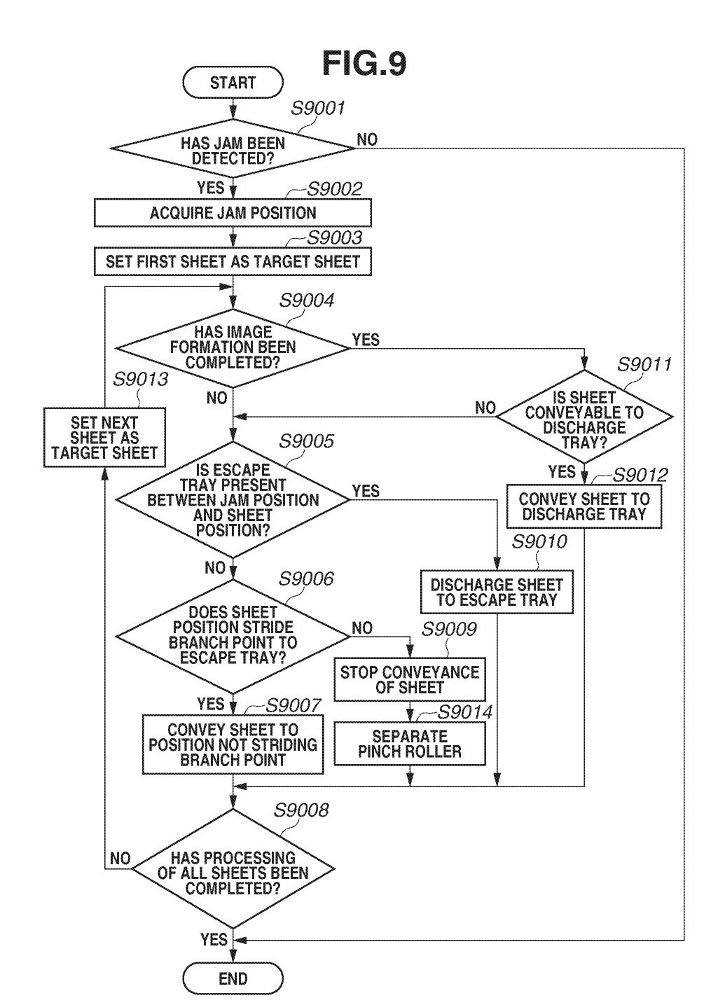

FIG. 9 is a flowchart of the sheet processing when a jam occurs. The processing and determination in the flowchart are performed by the CPU 1001 and the job management unit 1020.

In step S9001 in FIG. 9, the CPU 1001 determines whether a jam has been detected. In a case where a jam has been detected in step S9001 (YES in step S9001), the CPU 1001 acquires a position of a jam sheet in step S9002. In step S9003, the CPU 1001 sets a target sheet to be processed in order of the sheets positioned on the upstream side of the acquired position of the jam sheet.

In step S9004, the CPU 1001 determines whether image formation of the target sheet has been completed. In a case where image formation has not been completed (NO in step S9004), the CPU 1001 determines whether an escape tray is present on the conveyance path between the position of the jam sheet and the position of the target sheet in step S9005. In other words, the CPU 1001 determines whether the branch point at which the escape conveyance path extending toward the escape tray is branched is present between the target sheet and the jam occurrence position. For example, the CPU 1001 determines whether the branch point to the escape conveyance path 191 extending toward the feeding-unit escape tray 113 is present between the position of the target sheet and the jam occurrence position.

In a case where it is determined in step S9005 that the escape tray is absent (NO in step S9005), the CPU 1001 determines whether the position of the target sheet straddles the branch point (1101 in FIG. 8) of the escape conveyance path in step S9006.

In a case where it is determined in step S9006 that the position of the target sheet straddles the branch point (YES in step S9006), the CPU 1001 performs control not to stop the target sheet at that position in step S9007. For example, the CPU 1001 conveys the target sheet up to a downstream position not straddling the branch point to the escape conveyance path 191 extending toward the feeding-unit escape tray 113, and then stops the target sheet.

In step S9008, the CPU 1001 determines whether the processing on all the sheets under conveyance inside the apparatus has been completed. In a case where it is determined that the processing on all the sheets has been completed (YES in step S9008), the sheet processing ends.

In contrast, in a case where the sheet not processed remains in step S9008 (NO in step S9008), the CPU 1001 sets next sheet as the target sheet in step S9013, and the processing then returns to step S9004.

In a case where it is determined in step S9006 that the position of the target sheet does not straddle the branch point to the escape conveyance path (NO in step S9006), the CPU 1001 stops conveyance of the target sheet in step S9009. In step S9014, the CPU 1001 separates a conveyance pinch roller. The processing then returns to step S9008. Separation of the conveyance pinch roller is described below.

In a case where it is determined in step S9005 that the escape tray is present between the jam position and the position of the target sheet (YES in step S9005), the following operation is performed. In step S9010, the CPU 1001 discharges the target sheet to the escape tray through the escape conveyance path. The processing then returns to step S9008.

In a case where it is determined in step S9004 that the image formation has been completed (YES in step S9004), the processing proceeds to step S9011. In step S9011, the CPU 1001 determines whether the conveyance path from the position of the target sheet to the discharge tray that is an original discharge destination of the stacker unit 600 is secured, and the target sheet can be conveyed to the discharge tray. The discharge tray that is the original discharge destination is the discharge tray set as the discharge destination for the sheet on which image formation has been completed.

In a case where it is determined in step S9011 that the target sheet can be conveyed to the discharge tray (YES in step S9011), the CPU 1001 conveys and discharges the target sheet to the discharge tray in step S9012. The processing then returns to step S9008.

In a case where it is determined in step S9011 that the target sheet cannot be conveyed to the discharge tray (NO in step S9011), the processing returns to step S9005.

In a case where a jam has not been detected in step S9001 (NO in step S9001), the sheet processing ends.

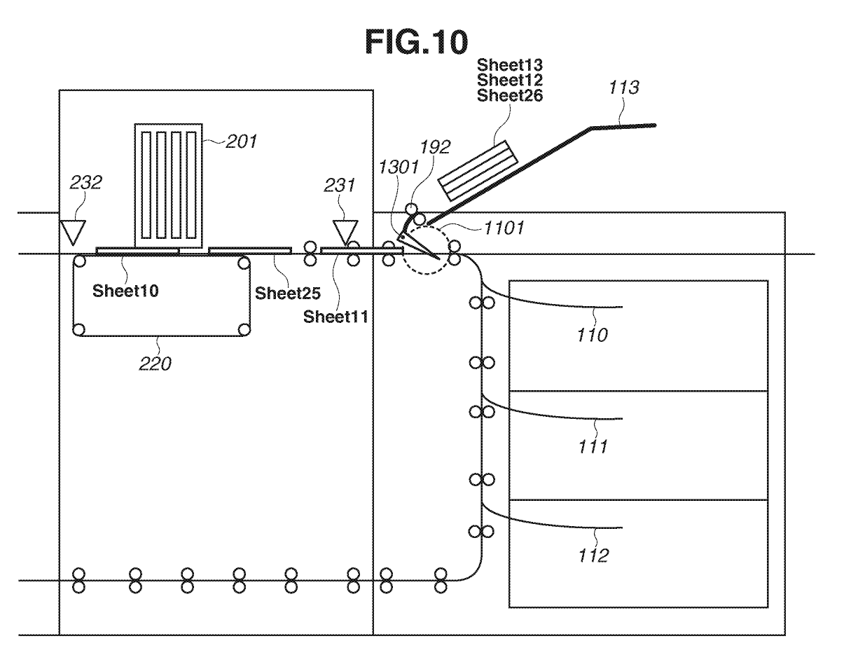

FIG. 10 is a diagram illustrating a state after the sheet processing when a jam is detected is performed in the state illustrated in FIG. 8. In FIG. 10, in a case where Sheet 10 is jammed at the position of the conveyance path sensor 232, Sheet 10 and Sheet 25 are stopped at those positions. Since Sheet 11 straddles the branch point 1101, Sheet 11 is stopped after being moved to a position where Sheet 11 does not straddle the branch point 1101. After Sheet 11 is moved, the sheets can be conveyed to the feeding-unit escape tray 113. Therefore, Sheet 26, Sheet 12, and Sheet 13 positioned on the upstream side of Sheet 11 are conveyed to the feeding-unit escape tray 113.

In FIGS. 10-12, the escape conveyance path 191 extending toward the feeding-unit escape tray 113 is described as an example of the escape conveyance path. The escape conveyance path extending toward the duplex-reversing escape tray 301 and the escape conveyance path extending toward the reversing-unit escape tray 501 are similar to the escape conveyance path 191 extending toward the feeding-unit escape tray 113. In other words, for example, when a sheet is present at a branch point to the escape conveyance path extending toward the duplex-reversing escape tray 301, the sheet is conveyed so as to be retracted from the branch point, and is then stopped. Thereafter, other sheets are discharged to the duplex-reversing escape tray 301.

Further, in the above description, the region from the tip of the switching flapper 1301 at the second position 1304 to the position 1305 of the shaft of the switching flapper 1301 is handled as the branch point 1101. In addition, in the case where even a part of the sheet is present in the region of the branch point 1101, it is determined that the sheet is present at the position inhibiting conveyance of the other sheets to the escape conveyance path 191. However, it is determined whether the sheet inhibits conveyance of the other sheets to the escape conveyance path 191, based on the configuration of the image forming apparatus such as arrangement of the flapper. In a case where the sheet is present at a position interfering with the tip of the switching flapper 1301 at the second position 1304, it may be determined that the sheet is present at the position inhibiting conveyance of the sheets to the escape conveyance path 191.

The processing in which, when a jam is detected, the sheet present at the position straddling the branch point to the escape conveyance path 191 is moved to the position not inhibiting conveyance to the escape conveyance path 191 and is then stopped to secure the escape conveyance path 191 is described above. Depending on a moving amount of the sheet, the sheet may collide with the conveyance pinch roller conveying a preceding sheet, and the sheet may be deformed by collision.

Therefore, in the present embodiment, processing for avoiding the collision by separating the conveyance pinch roller is performed. In the following, operation for avoiding the sheet from colliding with the conveyance pinch roller is described.

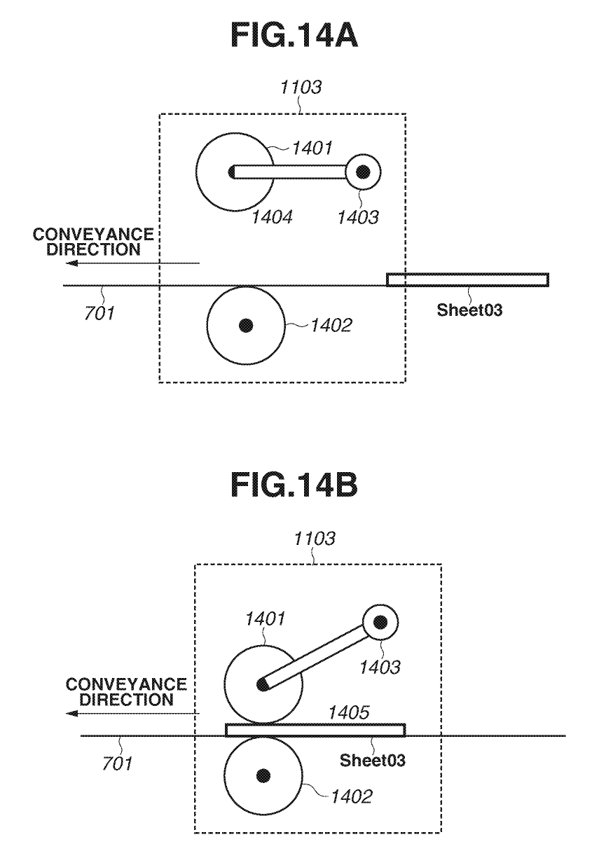

FIGS. 14A and 14B are diagrams illustrating a configuration of the conveyance pinch roller.

A conveyance pinch roller 1103 includes two rollers 1401 and 1402 that are vertically paired. In a case where the conveyance direction is a direction from a right side to a left side, the upper roller 1401 rotates in a clockwise direction, and the lower roller 1402 rotates in a counterclockwise direction. The upper roller 1401 is connected to a motor 1403 through an arm. When the motor 1403 rotates, a position of the roller 1401 can be vertically moved.

FIG. 14A illustrates a state of the conveyance pinch roller when no sheet is conveyed.

The upper roller 1401 is at a position 1404 separated from the lower roller 1402 (separated state), and rotation of the rollers is stopped.

FIG. 14B illustrates a state of the conveyance pinch roller when a sheet is conveyed. The upper roller 1401 is lowered to a position 1405 of the conveyance path 701, forms a nip with the lower roller 1402, and rotates while nipping the sheet to convey the sheet.

As described above, the conveyance pinch roller 1103 can be changed to a contact state where a roller nip capable of nipping the sheet is formed, and the separated state where the roller nip is not formed and the rollers are separated from each other.

In the present embodiment, all conveyance pinch rollers each have a similar separation configuration.

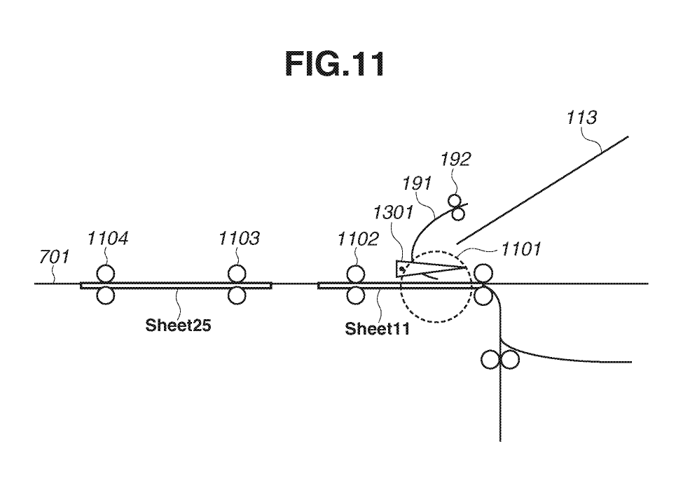

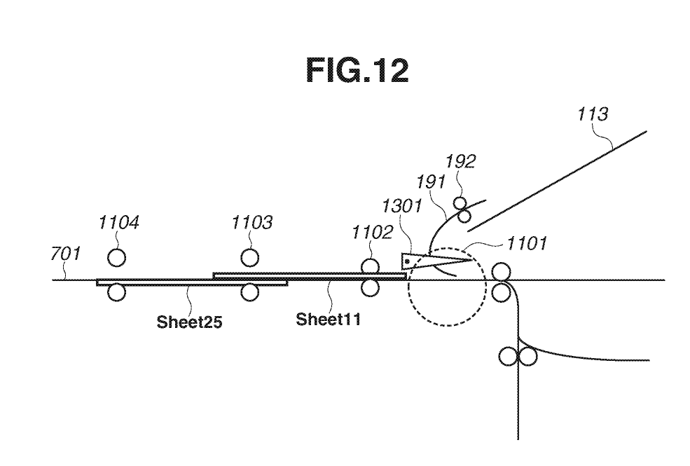

Next, separation of the conveyance pinch roller is described with reference to FIGS. 11 and 12.

FIG. 11 illustrates a state of the conveyance pinch roller during the print processing.

A first conveyance pinch roller 1102, a second conveyance pinch roller 1103, and a third conveyance pinch roller 1104 each including vertically paired rollers are provided on the conveyance path 701. When a sheet is conveyed, the first conveyance pinch roller 1102, the second conveyance pinch roller 1103, and the third conveyance pinch roller 1104 pinch and convey the sheet. In FIG. 11, Sheet 25 is pinched and conveyed by the second conveyance pinch roller 1103, and Sheet 11 is pinched and conveyed by the first conveyance pinch roller 1102.

FIG. 12 illustrates a state of each conveyance pinch roller at stop due to a jam.

When a jam is detected, Sheet 25 and Sheet 11 are stopped. At a time point when a jam is detected, Sheet 11 straddles the branch point 1101 for the feeding-unit escape tray 113. Therefore, by the above-described sheet processing (in step S9007 in FIG. 9), the first conveyance pinch roller 1102 moves Sheet 11 to a position where Sheet 11 does not straddle the branch point 1101. At this time, Sheet 11 may collide with the second conveyance pinch roller 1103 conveying Sheet 25 due to movement of Sheet 11. Therefore, in the present embodiment, the rollers of the second conveyance pinch roller 1103 and the rollers of the third conveyance pinch roller 1104 pinching Sheet 25 are separated (state illustrated in FIG. 14A). By separating the rollers, Sheet 11 does not collide with the second conveyance pinch roller 1103 and the third conveyance pinch roller 1104. Further, if the rollers of the second conveyance pinch roller 1103 are not separated from each other, Sheet 25 pinched by the second conveyance pinch roller 1103 may be conveyed to collide with the third conveyance pinch roller 1104. When the rollers of the second conveyance pinch roller 1103 and the rollers of the third conveyance pinch roller 1104 are separated, Sheet 25 does not collide with the third conveyance pinch roller 1104. Thereafter, Sheet 11 and Sheet 25 are stopped while overlapping with each other. Such operation makes it possible to avoid deformation of the sheet.

In an existing technique, among the sheets remaining inside the image forming apparatus, a sheet that is determined to be unable to complete image formation and cannot be conveyed to the escape tray unless the escape tray is present between a jam position and the sheet, is stopped at that position. At this time, if the sheet is stopped while straddling the branch point for the escape tray, the sheet blocks the conveyance path to the escape tray. If the conveyance path to the escape tray is blocked, sheets positioned on the upstream side of the stopped sheet cannot be conveyed to the escape tray. In this case, these sheets are stopped inside the image forming apparatus. As a result, the number of sheets remaining inside the image forming apparatus is increased, and usability in jam recovery cannot be improved.

In contrast to the existing technique, in the present embodiment, the sheet present at the position straddling the branch point for the escape tray is moved to a position where the sheet does not block the conveyance path to the escape tray. Since the conveyance path to the escape tray is secured, stagnating sheets can be discharged to the escape tray, and the number of sheets remaining inside the apparatus can be reduced. This improves usability in jam recovery.

In the above description, the inkjet head 201 is described as an example of the image forming unit; however, the image forming unit may be an electrophotographic image forming unit. The conveyance roller is described as an example of the conveyance unit; however, the conveyance unit may be a conveyance belt.

According to the present disclosure, usability in jam recovery is improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-078623, filed May 9, 2025, which is hereby incorporated by reference herein in its entirety.

What is claimed is:

1. An image forming apparatus comprising:
an image forming unit configured to form an image on a sheet;
a first discharge unit to which the sheet on which image formation is normally completed is discharged;
a first conveyance path provided from a feeding unit configured to feed the sheet up to the first discharge unit through the image forming unit, and through which the sheet passes;
a reversing conveyance path branched from the first conveyance path at a first branch portion, and configured to reverse a sheet conveyance direction of the sheet on which the image is formed on a first surface of the sheet;
a duplex conveyance path disposed on a downstream side of the reversing conveyance path in the sheet conveyance direction, and merged with the first conveyance path at a merging portion;
a second conveyance path branched from the first conveyance path at a second branch portion disposed on a downstream side of the merging portion and on an upstream side of the image forming unit, and through which the sheet passes toward a second discharge unit to which an abnormal sheet is discharged;
a jam detection unit configured to detect a jam of the sheet;
a conveyance unit configured to convey the sheet; and
a control unit configured to control the conveyance unit,
wherein, in a case where a jam occurring between the image forming unit and the first branch portion in the sheet conveyance direction is detected by the jam detection unit, the control unit controls the conveyance unit to convey a first sheet positioned at the second branch portion to a downstream of the second branch portion in the sheet conveyance direction, and then to convey a second sheet positioned on an upstream side of the second branch portion in the sheet conveyance direction to the second discharge unit.

2. The image forming apparatus according to claim 1,
wherein the conveyance unit includes a first roller pair disposed on the downstream side of the second branch portion in the sheet conveyance direction and configured to convey the sheet, and a second roller pair provided on a downstream side of the first roller pair and configured to convey the sheet,
wherein the second roller pair is changeable to a contact state where a nip for nipping the sheet is formed, and a separated state where a roller nip is not formed and rollers are separated from each other, and
wherein, in the case where a jam occurring between the image forming unit and the first branch portion in the sheet conveyance direction is detected by the jam detection unit, the second roller pair is changed from the contact state to the separated state, and the first roller pair conveys the first sheet to the downstream of the second branch portion in the sheet conveyance direction while the second roller pair is in the separated state.

3. The image forming apparatus according to claim 2, wherein the first roller pair is changeable to a contact state where a nip for nipping the sheet is formed, and a separated state where a roller nip is not formed and rollers are separated from each other.

4. The image forming apparatus according to claim 2, wherein, in the case where a jam occurring between the image forming unit and the first branch portion in the sheet conveyance direction is detected by the jam detection unit, the first roller pair conveys the first sheet to a position where the first sheet overlaps with a third sheet positioned on a downstream side of the first sheet in the sheet conveyance direction while the second roller pair is in the separated state.

5. The image forming apparatus according to claim 1, wherein, in the case where a jam occurring between the image forming unit and the first branch portion in the sheet conveyance direction is detected by the jam detection unit, the control unit stops a third sheet conveyed before the first sheet, and then stops the first sheet on the downstream side of the second branch portion in the sheet conveyance direction.

6. The image forming apparatus according to claim 1, wherein, in the case where a jam occurring between the image forming unit and the first branch portion in the sheet conveyance direction is detected by the jam detection unit, the control unit stops a plurality of sheets positioned on a downstream side of the first sheet and on an upstream side of a jam sheet in the first conveyance path.

7. The image forming apparatus according to claim 1, further comprising a third discharge unit branched from the first conveyance path on a downstream side of the first branch portion, and to which the abnormal sheet is discharged,
wherein, in the case where a jam occurring between the image forming unit and the first branch portion in the sheet conveyance direction is detected by the jam detection unit,
among a plurality of sheets positioned on a downstream side of a sheet on which the jam is detected in the first conveyance path, a sheet on which image formation on the first surface of the sheet and a second surface of the sheet is completed is discharged to the first discharge unit, and
among the plurality of sheets positioned on the downstream side of the sheet on which the jam is detected in the first conveyance path, a sheet on which image formation on the first surface of the sheet and the second surface of the sheet is not completed is discharged to the third discharge unit.

8. The image forming apparatus according to claim 1, further comprising a flapper disposed at the second branch portion and configured to move to a first position for guiding the sheet to the first discharge unit and a second position for guiding the sheet to the second discharge unit,
wherein, in the case where a jam occurring between the image forming unit and the first branch portion in the sheet conveyance direction is detected by the jam detection unit, the control unit conveys the first sheet positioned at a position inhibiting movement of the flapper to the second position, to the downstream of the second branch portion in the sheet conveyance direction.

9. The image forming apparatus according to claim 8,
wherein the flapper rotates around a shaft, and
wherein, in the case where a jam occurring between the image forming unit and the first branch portion in the sheet conveyance direction is detected by the jam detection unit, the control unit conveys the first sheet positioned in a region between a tip of the flapper and the shaft of the flapper, to the downstream of the second branch portion in the sheet conveyance direction.
